(19) United States
(12) Patent Application Publication
(10) Pub. No.: US 2002/0085121 A1
(43) Pub. Date: Jul. 4, 2002

(54) Image processing apparatus capable of changing active size and method for changing the active size thereof

(76) Inventor: Kye-won Ryou, Seoul (KR)

Correspondence Address: Robert E. Bushnell, Suite 300, 1522 K Street, N.W., Washington, DC, 20005-1202, US

(21) Appl. No.: 09/844,520

(22) Filed: Apr. 30, 2001

(30) Foreign Application Priority Data
Dec. 28, 2000 (KR) 00-84219

(51) Int. Cl. H04N 9/74

(52) U.S. Cl. 348/581; 348/582

(57) ABSTRACT

An image processing apparatus and a method for changing an active size performed therein are provided. In the image processing apparatus, a video decoder extracts a digital type first signal having brightness and color components of a×b pixels from an analog type image input signal and then outputs the first signal. A data extraction unit extracts the brightness and color components of c×d pixels (where c≦a, d≦b, and c×d indicates an active size) from the first signal and then stores a second signal having the extracted components. A scaling unit scales in horizontal and vertical directions the components included in the stored second signal in response to first and second predetermined ratios, respectively, and then outputs the scaled results. A control unit outputs a control signal determining the c and d to the data extraction unit and also outputs the first and second predetermined ratios as e/c and f/d, respectively, to the scaling unit in a case where an image is displayed with e×f pixels. The scaled results are used for displaying an image.

### CLAIM OF PRIORITY

This application makes reference to, incorporates the same herein, and claims all benefits accruing under 35 U.S.C. §119 from my application IMAGE PROCESSING APPARATUS CAPABLE OF CHANGING ACTIVE SIZE AND METHOD FOR CHANGING THE ACTIVE SIZE THEREOF filed with the Korean Industrial Property Office on Dec. 28, 2000 and there duly assigned Serial No. 84219/2000.

### BACKGROUND OF THE INVENTION

1. Technical Field

The present invention relates to an image processing apparatus such as a television, a digital video disk (DVD) player, a video cassette recorder (VCR), or a camcorder, and more particularly, to an image processing apparatus for scaling displayed images and an image processing method performed therein.

2. Related Art

In an image processing apparatus, the size of an active image which corresponds to a digital signal having brightness and color elements obtained from an analog image input signal, is called an active size. The active image has unstable regions in its upper, lower, left and right sides and the unstable regions are not displayed on a screen. The data in the regions excluded from a picture image being displayed is called garbage data.

An active size varies depending on which broadcasting station transmits an image signal and which program is broadcasted. However, in an image processing apparatus, the size of an active image used for displaying an image on a screen is fixed. That is, the active size is fixed. In other words, the size of an active region is fixed in the image processing apparatus. Consequently, an image part which corresponds to garbage data but may not be unstable may be omitted depending on the kind of broadcasting station and program, and information included in unstable regions may not be shown to users. In addition, even if the garbage data is sometimes regarded as useful in a field to which an image processing apparatus can be applied, such as a security field, an industrial field, or a medical field, the image processing apparatus cannot provide any image part belonging to the garbage data to users.

I have found that the limitations of the image processing units of the related art can be extremely inconvenient.

### SUMMARY OF THE INVENTION

To solve the above problems, it is a first object of the present invention to provide an image processing apparatus which is capable of freely changing an active size according to the preference of a user.

It is a second object of the present invention to provide a method for changing an active size performed in the image processing apparatus.

Accordingly, to achieve the first object of the invention, there is provided an image processing apparatus including a video decoder which extracts from an analog type image input signal a digital type first signal having brightness and color components of a×b pixels (where a and b indicate the number of pixels in a horizontal direction and a vertical direction, respectively) and outputs the first signal; a data extraction unit which extracts from the first signal brightness and color components of c×d pixels (where c≦a and d≦b and c×d indicates an active size) in response to a control signal and stores a second signal having the extracted components; a scaling unit which scales in horizontal and vertical directions the components included in the second signal in response to first and second predetermined ratios, respectively, and outputs the scaled results; and a control unit which outputs the control signal which is used in determining c and d to the data extraction unit, and in a case where an image is displayed with e×f pixels, outputs the first and second predetermined ratios as e/c and f/d, respectively, to the scaling unit, where the scaled results are used for displaying an image.

To achieve the second object of the invention, there is provided a method for changing an active size including the steps of determining c and d and the first and second predetermined ratios, extracting from the image input signal a digital type first signal having brightness and color components of a×b pixels, extracting from the first signal brightness and color components of c×d pixels from the first signal and storing the extracted components as a second signal and scaling in horizontal and vertical directions the components included in the second signal according to the first and second predetermined ratios, respectively.

To achieve these and other objects in accordance with the principles of the present invention, as embodied and broadly described, the present invention provides an image processing apparatus, comprising: a video decoder extracting a digital first signal from an analog input signal, and outputting said first signal, said first signal having brightness and color components of A×B pixels; a data extraction unit extracting a second signal from said first signal in response to a control signal, storing said second signal, said second signal having brightness and color components of C×D pixels, value of said C being not greater than value of said A, value of said D being not greater than value of said B; a scaling unit scaling horizontal direction components of said stored second signal in dependence upon a first ratio, scaling vertical direction components of said stored second signal in dependence upon a second ratio, outputting results of said scaling, said results of said scaling being used for displaying an image; and a control unit outputting said control signal to said data extraction unit, outputting said first and second ratios to said scaling unit, said first ratio corresponding to E/C and said second ratio corresponding to F/D when the image is to be displayed with E×F pixels.

To achieve these and other objects in accordance with the principles of the present invention, as embodied and broadly described, the present invention provides a method, comprising: determining value of C and value of D for C×D pixels, and determining first and second ratios; extracting a digital signal from an input signal, said digital signal having brightness and color components of A×B pixels; extracting a second signal from said first signal, storing said second signal, said second signal having brightness and color components of said C×D pixels; and scaling the components of said stored second signal in a first direction in dependence upon said first ratio, scaling the components of said stored second signal in a second direction in dependence upon said second ratio.

To achieve these and other objects in accordance with the principles of the present invention, as embodied and broadly described, the present invention provides a method for changing the active size performed in an image processing apparatus, said method comprising: determining value of C and value of D, and determining first and second ratios, said value of said C corresponding to a number of pixels in a horizontal direction, said value of said D corresponding to a number of pixels in a vertical direction, said first and second ratios being determined in dependence upon preset conditions, C×D pixels corresponding to a first active size; extracting a digital signal from an input analog signal, said digital signal having brightness and color components of A×B pixels, value of said A corresponding to a number of pixels in said horizontal direction, value of said B corresponding to a number of pixels in said vertical direction; extracting a second signal from said first signal, and storing said second signal, said second signal having brightness and color components of said C×D pixels; scaling the components of said stored second signal in said horizontal direction in dependence upon said first ratio, scaling the components of said stored second signal in said vertical direction in dependence upon said second ratio, results of said scaling corresponding to a second active size; and outputting said results of said scaling, said results of said scaling being used for displaying an image corresponding to said second active size different than said first active size.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a block diagram of an image processing apparatus which is capable of changing an active size, in accordance with the principles of the present invention; and

FIG. 2 is a flowchart illustrating a method for changing an active size, in accordance with the principles of the present invention, which is performed in the image processing apparatus illustrated in FIG. 1.

### DETAILED DESCRIPTION OF THE PRESENT INVENTION

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions or constructions are not described in detail since they would obscure the invention in unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Hereinafter, the structure and operation of an image processing apparatus which is capable of changing an active size and a method for changing the active size performed therein according to the present invention will be described in detail with reference to the attached drawings.

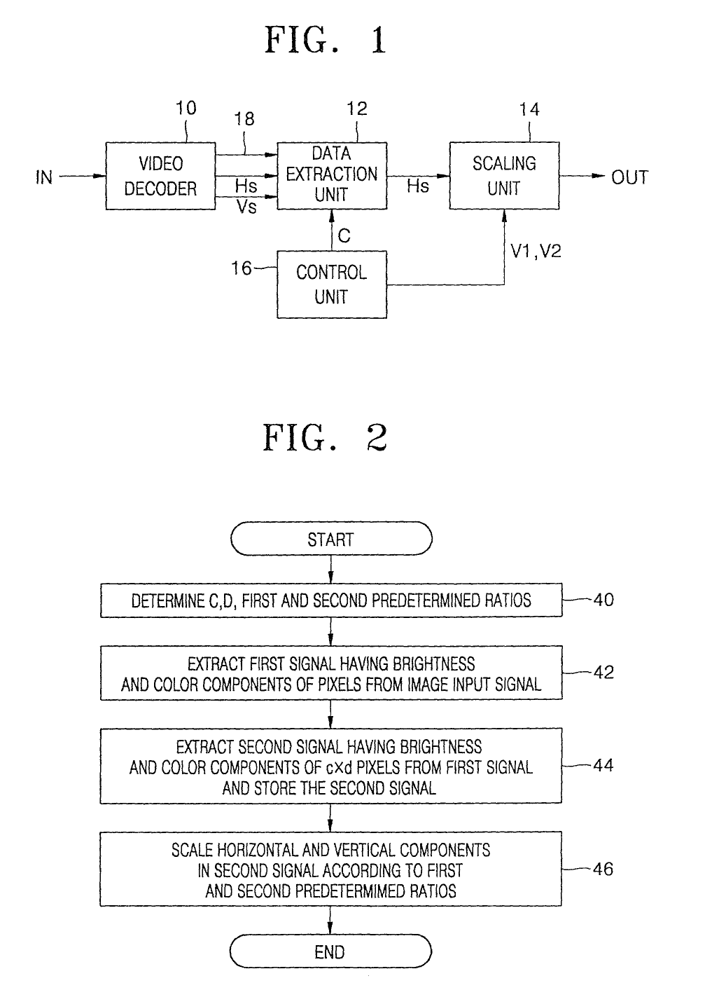

FIG. 1 is a block diagram of an image processing apparatus which is capable of changing an active size according to the present invention. In this figure, the image processing apparatus includes a video decoder 10, a data extraction unit 12, a scaling unit 14 and a control unit 16.

FIG. 2 is a flow chart illustrating a method for changing an active size according to the present invention, which is performed in the apparatus illustrated in FIG. 1. The method for changing an active size according to the present invention includes steps 40 through 46 for extracting brightness and color components belonging to an active size determined according to a user's requirements and scaling the components up or down to a desired size.

To perform the method for changing an active size according to the present invention, in step 40, the control unit 16 determines an active size c×d (c and d indicate the numbers of pixels of an active image in horizontal and vertical directions, respectively), and outputs a control signal C having information on the determined active size to the data extraction unit 12. In addition, the control unit 16 determines first and second predetermined ratios V1 and V2 and then outputs the ratios to the scaling unit 14. Here the active size can be determined arbitrarily by a user or it can be previously set so as to have various values and then can be stored in the control unit 16. Also, the control unit 16 determines the ratio of the number e of pixels in a horizontal direction among pixels forming an image which will be finally displayed to the total number c of pixels of the active image in a horizontal direction as the first predetermined ratio V1, and determines the ratio of the number f of pixels in a vertical direction among pixels forming an image which will be finally displayed to the total number d of pixels of the active image in a vertical direction as the second predetermined ratio V2. To display an e×f-pixel image, the control unit 16 determines the first and second predetermined ratios V1 and V2 as e/c and f/d, respectively, and outputs the ratios to the scaling unit 14.

Next, in step 42, the video decoder 10 extracts from an analog type image input signal inputted via an input terminal IN a digital type first signal having brightness and color components of a×b pixels. Then, the video decoder 10 outputs the first signal 18 to the data extraction unit 12. Here, the analog type image input signal may be a composite video baseband signal (CVBS) or a super video home system (S-VHS) signal having a brightness signal Y and a color signal C, or the image input signal may be a signal having three components, that is, a brightness signal Y and color-difference signals Cr and Cb. For example, the first signal 18 can be YUV (Y indicates the brightness signal, and U and V indicate the color-difference signals). In addition, the video decoder 10 extracts digital horizontal and vertical synchronous signals Hs and Vs from the image input signal and then outputs the extracted signals to the data extraction unit 12.

Next, in step 44, the data extraction unit 12 extracts brightness and color components of c×d pixels (where c≦a and d≦b) from the first signal 18 inputted from the video decoder 10, in response to the control signal C outputted from the control unit 16. Then, the data extraction unit 12 stores a second signal having the extracted components in its built-in memory (not shown). For example, suppose there are a pixels in a horizontal direction of the first signal 18 and unstable pixels among the a pixels ranging from the first pixel to the g-th pixel and from the a-g+1-th pixel to the last pixel. In this case, in response to the control signal C during a unit period of the horizontal synchronous signal Hs, the data extraction unit 12 extracts the brightness and color components of a-2g pixels ranging from the g+1-th pixel to the a-g-th pixel, but leaves the 2g unstable pixels and then stores the extracted components as the second signal. At this time, the data extraction unit 12 determines g based on the control signal C. Suppose again there are b pixels in a vertical direction of the first signal 18 and unstable pixels among these pixels ranging from the first pixel to the g-th pixel and from the b-g+1-th pixel to the last pixel. Then, in response to the control signal C during a unit period of the vertical synchronous signal Vs, the data extraction unit 12 extracts the brightness and color components of b-2g pixels ranging from the g+1-th pixel to b-g-th pixel, but leaves the 2g unstable pixels, and then stores the extracted components as the second signal. Therefore, the second signal includes the brightness and color components of a-2g pixels in the horizontal direction and b-2g pixels in the vertical direction.

Next, in step 46, in response to the first and second predetermined ratios V1 and V2 (e/c and f/d) inputted from the control unit 16, respectively, the scaling unit 14 scales the brightness and color components of the pixels in the horizontal and vertical directions included in the second signal, which are stored in the data extraction unit 12 and then outputs the scaled result via an output terminal OUT. For example, the scaling unit 14 obtains information on the brightness and color of e pixels in the horizontal direction through the use of information on the brightness and color of c pixels in the same direction. Also, the scaling unit 14 obtains information on the brightness and color of f pixels in the vertical direction through the use of information on the brightness and color of d pixels in the same direction. When a scaling process for increasing the number of pixels is performed, that is, when e>c and f>d, the scaling unit 14 interpolates the brightness and color components of pixels which do not have brightness and color components among e pixels, that is, pixels (hereinafter, referred to as unknown pixels) whose brightness and color components are not included in the second signal. There are various methods for interpolating the brightness and color components of the unknown pixels. For example the brightness and color components of an unknown pixel can be obtained by averaging the brightness and color components of its neighboring pixels (hereinafter, referred to as known pixels) having brightness and color components included in the second signal. Consequently, the scaling unit 14 synthesizes the brightness and color components of the known and unknown pixels and then outputs the scaled results via the output terminal OUT. After being outputted via the output terminal OUT, the scaled results are converted into RGB data and the RGB data is used for displaying an e×f sized image.

For a better understanding of the present invention, suppose a=640, b=480, e=1024, f=768, g may be 10 or 5 and an active size, c×d, may be 620×460 or 630×470.

In step 40, the control unit 16 sets an active size (c×d) at 620×460 and then outputs a control signal C having information on the active size to the data extraction unit 12. The control unit 16 fixes first and second predetermined ratios V1 and V2 or e/c and f/d at 1024/620 and 768/460, respectively, and then outputs the results to the scaling unit 14.

Next, in step 42, the video decoder 10 extracts a digital type first signal 18, which includes brightness and color components of 640×480 pixels, from an analog type image input signal inputted via an input terminal IN.

Next, in step 44, the data extraction unit 12 extracts the brightness and color components of 620 pixels among 640 pixels in the horizontal direction, but leaves unstable pixels ranging from the first pixel to the tenth pixel and from the 631st pixel to the 640th pixel. Also in step 44, the data extraction unit 12 extracts the brightness and color components of 460 pixels among 480 pixels in the vertical direction, but leaves unstable pixels ranging from the first pixel to the tenth pixel and from the 471st pixel to the 480th pixel. Then, the data extraction unit 12 stores the extracted components as a second signal.

Next, in step 46, the scaling unit 14 scales the 620 horizontal pixels included in the second signal to the first predetermined ratio V1 of 1024/620 and also scales the 460 vertical pixels included in the second signal to the second predetermined ratio of 768/460. Then, the scaling unit 12 finds the brightness and color components of 1024 horizontal pixels and 768 vertical pixels as the scaled result. The brightness and color components of 1024×768 pixels are used for displaying an image having a size of 1024×768 on a screen.

According to the method for changing an active size, in a case where the active size is changed from 620×460 to 630×470, the control unit 16 outputs a control signal C having information on the determined active size to the data extraction unit 12, sets a first predetermined ratio V1 or e/c and a second predetermined ratio V2 or f/d to 1024/630 and 768/470, respectively, and then outputs the results to the scaling unit 14 in step 40. Next, the brightness and color components included in the first signal 18 extracted in step 42 are still for 640×480 pixels even if the active size is changed.

Next, in step 42, the data extraction unit 12 extracts the brightness and color components of 630 pixels among 640 pixels in the horizontal direction, but leaves unstable pixels ranging from the first pixel to the 5th pixel and from the 636th pixel to the 640th pixel and also picks out the brightness and color components of 470 pixels among 480 pixels in the vertical direction, but leaves unstable pixels ranging from the first pixel to the 5th pixel and from the 476th pixel to the 480th pixel. Then the data extraction unit 12 stores the extracted components as a second signal.

Next, in step 46, the scaling unit 14 scales the 630 horizontal pixels included in the second signal to the first predetermined ratio V1 of 1024/630 and also scales the 470 vertical pixels included in the second signal to the second predetermined ratio V2 of 768/470. Then, the scaling unit 12 finds the brightness and color components of 1024 horizontal pixels and 768 vertical pixels as the scaled result. The brightness and color components of 1024×768 pixels are used for displaying an image having a size of 1024×768 on a screen.

In the above examples, an active size can be changed into two different kinds, however, the present invention is not limited to these examples. Therefore, it is also possible to change an active size into three or more different kinds. Thus, an image processing apparatus other than the present invention is limited because that apparatus fixes an active size to only one size, such as either 620×460 or 630×470. However, the image processing apparatus and the method for changing an active size performed therein, in accordance with the principles of the present invention, make it possible to freely change an active size from 620×460 to 630×470, thereby displaying a desired part of an image on a screen.

As described above, the image processing process and the method for changing an active size performed therein according to the present invention can display more parts of an image on a screen by freely changing an active size according to a user's preference, thereby satisfying users who want to get much more image information in a medical field, an industrial field or a security field, for example. Also, according to the present invention, the number of unknown pixels to be interpolated can be reduced through the adjustment of the active size, so that a high-quality image can be obtained.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An image processing apparatus, comprising:
a video decoder extracting a digital first signal from an analog input signal, and outputting said first signal, said first signal having brightness and color components of A×B pixels;
a data extraction unit extracting a second signal from said first signal in response to a control signal, storing said second signal, said second signal having brightness and color components of C×D pixels, value of said C being not greater than value of said A, value of said D being not greater than value of said B;
a scaling unit scaling horizontal direction components of said stored second signal in dependence upon a first ratio, scaling vertical direction components of said stored second signal in dependence upon a second ratio, outputting results of said scaling, said results of said scaling being used for displaying an image; and
a control unit outputting said control signal to said data extraction unit, outputting said first and second ratios to said scaling unit, said first ratio corresponding to E/C and said second ratio corresponding to F/D when the image is to be displayed with E×F pixels.

2. The apparatus of claim 1, said analog input signal being an analog composite image signal.

3. The apparatus of claim 1, said analog input signal being a super video home system signal.

4. The apparatus of claim 1, said data extracting unit determining said value of C and said value of D in dependence upon said control signal.

5. The apparatus of claim 1, said first and second ratios being predetermined.

6. The apparatus of claim 1, said E and said F being selected by a user.

7. The apparatus of claim 1, said value of said A corresponding to a number of pixels in a horizontal direction, said value of said B corresponding to a number of pixels in a vertical direction, said value of said C corresponding to a number of pixels in said horizontal direction, said value of said D corresponding to a number of pixels in said vertical direction, value of said E corresponding to a number of pixels in said horizontal direction, value of said F corresponding to a number of pixels in said vertical direction.

8. The apparatus of claim 7, said value of said E and said value of said F being selected by a user.

9. The apparatus of claim 8, said C×D corresponding to a first active size, said first active size being different from size of the image displayed in accordance with said results of said scaling.

10. The apparatus of claim 1, said analog input signal including image data.

11. The apparatus of claim 1, said C×D corresponding to a first active size.

12. The apparatus of claim 11, said first active size being different from size of the image displayed.

13. A method, comprising:
determining value of C and value of D for C×D pixels, and determining first and second ratios;
extracting a digital signal from an input signal, said digital signal having brightness and color components of A×B pixels;
extracting a second signal from said first signal, storing said second signal, said second signal having brightness and color components of said C×D pixels; and
scaling the components of said stored second signal in a first direction in dependence upon said first ratio, scaling the components of said stored second signal in a second direction in dependence upon said second ratio.

14. The method of claim 13, said first direction corresponding to a horizontal direction, said second direction corresponding to a vertical direction.

15. The method of claim 14, value of said A corresponding to a number of pixels in said horizontal direction, value of said B corresponding to a number of pixels in said vertical direction, said value of said C corresponding to a number of pixels in said horizontal direction, said value of said D corresponding to a number of pixels in said vertical direction.

16. The method of claim 15, said first ratio corresponding to E/C and said second ratio corresponding to F/D, when an image is to be displayed with E×F pixels.

17. The method of claim 16, said value of said C being not greater than said value of said A, said value of said D being not greater than said value of said B.

18. The method of claim 13, value of said A corresponding to a number of pixels in said first direction, value of said B corresponding to a number of pixels in said second direction, said value of said C corresponding to a number of pixels in said first direction, said value of said D corresponding to a number of pixels in said second direction.

19. The method of claim 18, said first ratio corresponding to E/C and said second ratio corresponding to F/D, when an image is to be displayed with E×F pixels.

20. The method of claim 13, said first ratio corresponding to E/C and said second ratio corresponding to F/D, when an image is to be displayed with E×F pixels.

21. The method of claim 20, value of said E corresponding to a number of pixels in said first direction, value of said F corresponding to a number of pixels in said second direction.

22. The method of claim 21, said E and said F being selected by a user.

23. The method of claim 22, said value of said C being not greater than value of said A, said value of said D being not greater than value of said B.

24. A method for changing the active size performed in an image processing apparatus, said method comprising:
determining value of C and value of D, and determining first and second ratios, said value of said C corresponding to a number of pixels in a horizontal direction, said value of said D corresponding to a number of pixels in a vertical direction, said first and second ratios being determined in dependence upon preset conditions, C×D pixels corresponding to a first active size;
extracting a digital signal from an input analog signal, said digital signal having brightness and color components of A×B pixels, value of said A corresponding to a number of pixels in said horizontal direction, value of said B corresponding to a number of pixels in said vertical direction;
extracting a second signal from said first signal, and storing said second signal, said second signal having brightness and color components of said C×D pixels;
scaling the components of said stored second signal in said horizontal direction in dependence upon said first ratio, scaling the components of said stored second signal in said vertical direction in dependence upon said second ratio, results of said scaling corresponding to a second active size; and
outputting said results of said scaling, said results of said scaling being used for displaying an image corresponding to said second active size different than said first active size.

25. The method of claim 24, said value of said C being not greater than said value of said A, said value of said D being not greater than said value of said B.

26. The method of claim 25, said input analog signal corresponding to an analog composite image signal.

27. The method of claim 25, said input analog signal corresponding to a super video home system signal.

28. The method of claim 25, said first ratio corresponding to E/C and said second ratio corresponding to F/D, when an image is to be displayed with E×F pixels.

29. The method of claim 28, value of said E corresponding to a number of pixels in said horizontal direction, value of said F corresponding to a number of pixels in said vertical direction.

30. The method of claim 29, value of said E and value of said F being selected by a user.
